(19) United States
(12) Patent Application Publication
(10) Pub. No.: US 2007/0273931 A1
(43) Pub. Date: Nov. 29, 2007

(54) Image enhancing method and image enhancing apparatus

(75) Inventor: Kosuke Shingai, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/807,431

(22) Filed: May 29, 2007

(30) Foreign Application Priority Data
May 29, 2006 (JP) 2006-148436

(51) Int. Cl. H04N 1/409

(52) U.S. Cl. 358/3.27

(57) ABSTRACT

An image enhancing method includes: (A) classifying a plurality of target frames that are to be output into at least one group based on a predetermined criterion, the target frames being determined from among a plurality of frames constituting a file; and (B) performing image enhancement on the target frames belonging to a particular group, uniformly under a condition that is associated with the particular group.

### CROSS-REFERENCE TO RELATED APPLICATIONS

The present application claims priority upon Japanese Patent Application No. 2006-148436 filed on May 29, 2006, which is herein incorporated by reference.

### BACKGROUND

1. Technical Field

The present invention relates to image enhancing methods and image enhancing apparatuses.

2. Related Art

There are apparatuses that acquire a predetermined number of successive frames from one moving image file and perform printing (see JP-A-2004-120638, for example). In these apparatuses, the frames obtained from the moving image file are treated as still images. Thus, when the images are enhanced, techniques for still images are used.

In the case of frames acquired from a moving image file, a scene may be changed midway through the frames. In this case, it is preferable to make the enhancing methods uniform depending on scenes. For example, in frames which mainly contain a person, it is preferable to enhance the images with the person focused on. In frames mainly containing scenery, it is preferable to enhance the images so as to make the scenery vivid.

### SUMMARY

The invention was arrived at in view of these circumstances, and it is an advantage thereof to achieve appropriate image enhancement for a plurality of frames that have been acquired from a file.

In order to achieve the above-described advantage, a primary aspect of the invention is directed to an image enhancing method, including:

(A) classifying a plurality of target frames that are to be output into at least one group based on a predetermined criterion, the target frames being determined from among a plurality of frames constituting a file; and

(B) performing image enhancement on the target frames belonging to a particular group, uniformly under a condition that is associated with the particular group.

Features of the invention other than the above will become clear by reading the description of the present specification with reference to the accompanying drawings.

### BRIEF DESCRIPTION OF THE DRAWINGS

For a more complete understanding of the invention and the advantages thereof, reference is now made to the following description taken in conjunction with the accompanying drawings.

FIG. 1A is a perspective view illustrating the external appearance of a multifunctional machine.

FIG. 1B is a view illustrating a control panel.

FIG. 2 is a block diagram illustrating the configuration of the multifunctional machine.

FIG. 3 is a view illustrating a printing mechanism.

FIG. 4 is a flowchart illustrating each of the processes in a printing operation.

FIG. 5 is a flowchart illustrating a second image quality adjusting process.

FIG. 6 is a view illustrating one example of a user interface when selecting a moving image file.

FIG. 7 is a view illustrating one example of the user interface in a start/end frame determining process.

FIG. 8 is a view illustrating one example of the user interface when determining a start frame.

FIG. 9 is a view illustrating one example of the user interface when determining an end frame.

FIG. 10 is a diagram for illustrating target frames.

FIG. 11 shows one example of a display screen on a display section in a second printing process.

FIG. 12 is a view showing one example of printed images.

FIG. 13 is a diagram schematically illustrating a grouping process.

FIG. 14 is a diagram illustrating the classification items of each of the target frames.

### DESCRIPTION OF EXEMPLARY EMBODIMENTS

At least the following matters will be made clear by the explanation in the present specification and the description of the accompanying drawings.

More specifically, it is possible to realize an image enhancing method, including:

(A) classifying a plurality of target frames that are to be output into at least one group based on a predetermined criterion, the target frames being determined from among a plurality of frames constituting a file; and

(B) performing image enhancement on the target frames belonging to a particular group, uniformly under a condition that is associated with the particular group.

With this image enhancing method, image enhancement is performed under a uniform condition on a plurality of target frames belonging to a particular group. Thus, the image enhancement is performed under a condition that is suitable for that group, and thus appropriate image enhancement can be achieved.

In this image enhancing method, it is preferable that the plurality of target frames are classified into a plurality of groups according to a type of an object in a frame.

With this image enhancing method, appropriate image enhancement can be achieved for each type of objects in the frames.

In this image enhancing method, it is preferable that image enhancement on the target frames belonging to the particular group is performed uniformly under a condition that is associated with the particular group, and image enhancement on the target frames belonging to another group is performed uniformly under a condition that is associated with the other group.

With this image enhancing method, appropriate image enhancement can be achieved for a plurality of types of groups.

In this image enhancing method, it is preferable that the plurality of target frames are classified into a plurality of groups without specifying the type, and

the type is specified for each group after the target frames are classified into the plurality of groups.

With this image enhancing method, the object-based type is specified for each group. Thus, the process can be made efficient.

In this image enhancing method, it is preferable that the plurality of target frames are classified into the plurality of groups, by comparing luminance values among the successive target frames.

With this image enhancing method, the target frames are divided into groups using the luminance values. Thus, the process can be made simple.

In this image enhancing method, it is preferable that a representative frame is determined from among the target frames belonging to a particular group, and a type of the representative frame is taken as the type of the particular group.

With this image enhancing method, the type of the group is determined based on the representative frame. Thus, the process can be made simple.

In this image enhancing method, it is preferable that the type of an object in a frame includes at least a person type.

With this image enhancing method, appropriate enhancement can be achieved for a group that is associated with the person type.

In this image enhancing method, it is preferable that image enhancement on the target frames belonging to a group that is associated with the person type is performed uniformly under a condition that is determined based on an image of a face portion of a person.

With this image enhancing method, appropriate enhancement can be achieved for an image of a person.

In this image enhancing method, it is preferable that the type of an object in a frame includes at least a scenery type.

With this image enhancing method, appropriate enhancement can be achieved for a group that is associated with the scenery type.

In this image enhancing method, it is preferable that image enhancement on the target frames belonging to a group that is associated with the scenery type is performed uniformly under a condition that is determined based on colors constituting scenery.

With this image enhancing method, appropriate enhancement can be achieved for an image of scenery.

In this image enhancing method, it is preferable that the plurality of target frames are determined based on information for specifying a particular frame and information for specifying another frame that is recorded after the particular target frame.

With this image enhancing method, the control is easy.

Furthermore, it is also clear that an image enhancing apparatus below can be realized.

More specifically, it is possible to realize an image enhancing apparatus, including:

(A) a group classifying section for classifying a plurality of target frames that are to be output into at least one group based on a predetermined criterion, the target frames being determined from among a plurality of frames constituting a file; and

(B) an image enhancing section for performing image enhancement on the target frames belonging to a particular group, uniformly under a condition that is associated with the particular group.

### First Embodiment

### Regarding the Image Enhancing Apparatus

An image enhancing apparatus can be realized in various embodiments. For example, it is possible to use a computer as the image enhancing apparatus, by making the computer execute a program for image enhancement. A digital camera and a printing apparatus have a controller. It is possible to use the digital camera or printing apparatus as the image enhancing apparatus, by making the controller to execute a program for image enhancement. Thus, in this specification, a description is made taking a printer-scanner multifunctional machine (hereinafter, also simply referred to as a “multifunctional machine”) as an example. The multifunctional machine is an apparatus having a printing function to print an image on a medium and a reading function to read an image printed on a medium.

### Regarding the Configuration of Multifunctional Machine 1

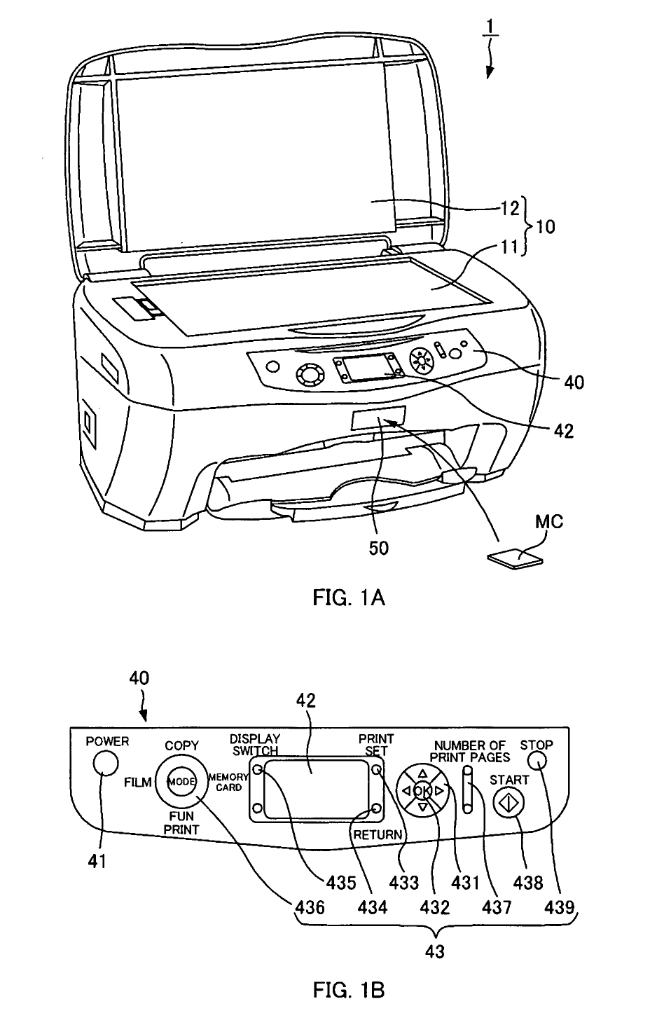

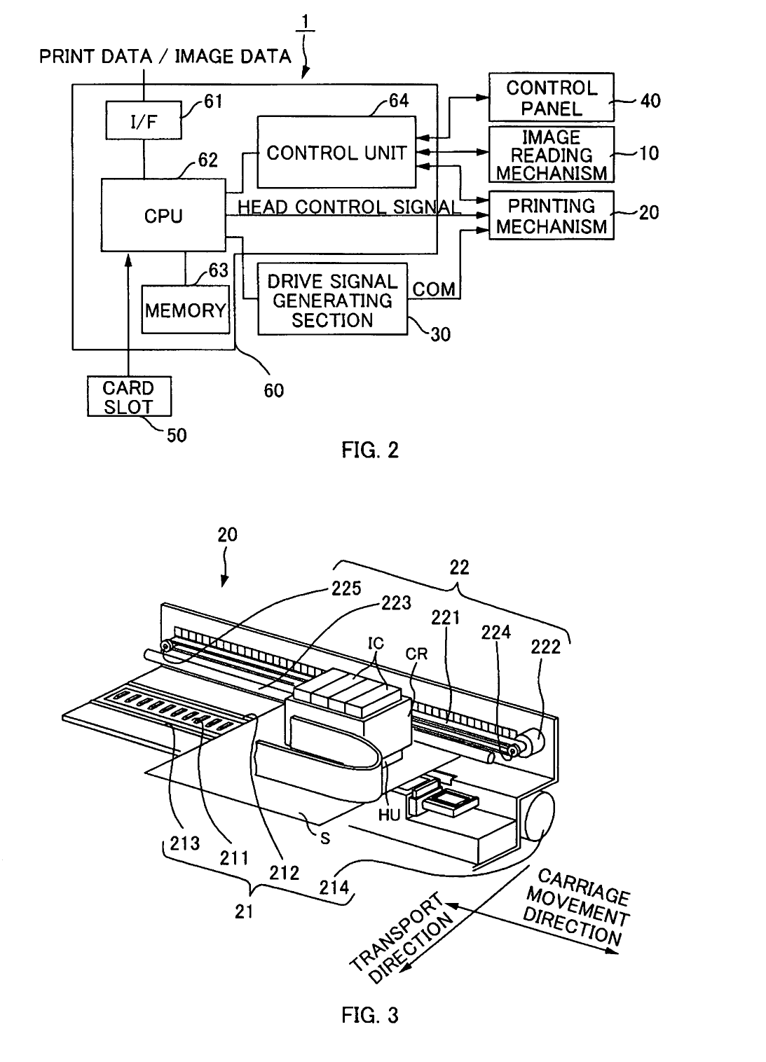

FIG. 1A is a perspective view illustrating the external appearance of a multifunctional machine 1. FIG. 1B is a view illustrating a control panel 40. FIG. 2 is a block diagram illustrating the configuration of the multifunctional machine 1. FIG. 3 is a view illustrating a printing mechanism 20. The multifunctional machine 1 has an image reading mechanism 10, the printing mechanism 20, a drive signal generating section 30, the control panel 40, a card slot 50, and a controller 60. In the multifunctional machine 1, the controller 60 controls sections that are to be controlled, that is, the image reading mechanism 10, the printing mechanism 20, and the drive signal generating section 30.

### Regarding the Image Reading Mechanism 10

The image reading mechanism 10 corresponds to an image reading section, and has an original document platen glass 11, an original document platen glass cover 12, a reading carriage, and a moving mechanism of the reading carriage. It should be noted that the reading carriage and the moving mechanism of the reading carriage are not shown in the drawings. The original document platen glass 11 is constituted by a transparent plate member such as glass. The original document platen glass cover 12 is configured so as to be opened and closed on a hinge. In the closed state, the original document platen glass cover 12 covers the original document platen glass 11 from above. The reading carriage is for reading the image density of a document that is placed on the original document platen glass 11. The reading carriage has components such as a CCD image sensor, a lens, and an exposure lamp. The moving mechanism of the reading carriage is for moving the reading carriage. The moving mechanism has components such as a support rail and a timing belt. In the image reading mechanism 10, when reading an image, the moving mechanism moves the reading carriage. Accordingly, the reading carriage outputs electric signals corresponding to image densities.

### Regarding the Printing Mechanism 20

The printing mechanism 20 is a component for printing an image onto paper S which serves as a medium, and corresponds to an image printing section. The printing mechanism 20 has a paper transport mechanism 21, a carriage CR, and a carriage moving mechanism 22. The paper transport mechanism 21 is for transporting the paper S in a transport direction, and has a platen 211 that supports the paper S from the rear face side, a transport roller 212 that is disposed on the upstream side of the platen 211 in the transport direction, a paper discharge roller 213 that is disposed on the downstream side of the platen 211 in the transport direction, and a transport motor 214 that serves as the driving source of the transport roller 212 and the paper discharge roller 213. The carriage CR is a component to which ink cartridges IC and a head unit HU are attached. In a state of being attached to the carriage CR, a head (not shown) of the head unit HU opposes the platen 211. The carriage moving mechanism 22 is for moving the carriage CR in a carriage movement direction. The carriage moving mechanism 22 has a timing belt 221, a carriage motor 222, and a guide shaft 223. The timing belt 221 is connected to the carriage CR, and is stretched around a drive pulley 224 and an idler pulley 225. The carriage motor 222 is the driving source for rotating the drive pulley 224. The guide shaft 223 is a component for guiding the carriage CR in the carriage movement direction. In the carriage moving mechanism 22, it is possible to move the carriage CR in the carriage movement direction, by operating the carriage motor 222.

### Regarding the Drive Signal Generating Section 30

The drive signal generating section 30 is a component for generating drive signals COM that are used when making the ink to be ejected from the head. The drive signal generating section 30 generates drive signals COM of various waveforms, based on control signals from the controller 60 (CPU 62).

### Regarding the Control Panel 40

The control panel 40 constitutes a user interface in the multifunctional machine 1. The control panel 40 is provided with a power button 41, a display section 42, and an input section 43. The power button 41 is a button that is used when turning on/off the power of the multifunctional machine 1. The display section 42 consists of, for example, a liquid crystal display panel. The display section 42 displays, for example, a menu screen and images (frames of a moving image file) that are to be printed. The input section 43 consists of various buttons. In this example, the input section 43 consists of a four-way button 431, an OK button 432, a print setting button 433, a return button 434, a display switching button 435, a mode switching button 436, a button 437 for increasing/decreasing the number of print pages, a start button 438, and a stop button 439. The four-way button 431 is used when moving items and the like, for example. The OK button 432 is used when fixing a selected item, for example. The print setting button 433 is used when setting printing. The return button 434 is used when returning the display to the previous state, for example. The display switching button 435 is used when switching the display mode and the like. It is used when switching between a thumbnail display and an enlarged display of images, for example. The mode switching button 436 is used when switching the operation mode of the multifunctional machine 1, for example. The button 437 for increasing/decreasing the number of print pages is used when adjusting the number of print pages, for example. The start button 438 is used when starting an operation. It is used when starting printing, for example. The stop button 439 is used when stopping the certain operation. It is used when stopping printing, for example. These buttons have switches (not shown) for outputting signals corresponding to operations. The switches are electrically connected to the controller 60. Accordingly, the controller 60 recognizes the operations corresponding to each of the buttons based on the signals from the switches, and operates in correspondence with the recognized operations.

### Regarding the Card Slot 50

The card slot 50 is a component that is electrically connected to a memory card MC (corresponding to an external memory, and also to a moving image file memory). Thus, the card slot 50 is provided with an interface circuit that is to be electrically connected to the memory card MC. The memory card MC that can be attached to and detached from the card slot 50 stores data that is to be printed. For example, the memory card MC stores moving image files and still image files that have been photographed with a digital camera.

### Regarding the Controller 60

The controller 60 has an interface section 61, a CPU 62, a memory 63, and a control unit 64. The interface section 61 exchanges data with a computer (not shown) serving as an external apparatus. The interface section 61 can exchange data also with a digital camera that is connected via a cable. The CPU 62 is an arithmetic processing unit for performing the overall control of the multifunctional machine 1. The memory 63 is for securing, for example, an area for storing computer programs and a working area, and is constituted by storage elements such as a RAM, an EEPROM, or a ROM. The CPU 62 controls each of the sections that are to be controlled, based on computer programs stored in the memory 63. For example, the CPU 62 controls the image reading mechanism 10, the printing mechanism 20, and the control panel 40 (the display section 42), via the control unit 64.

### Regarding the Operation of the Multifunctional Machine 1

### Regarding the Outline of the Operation

In the multifunctional machine 1, electronic data of images read by the image reading mechanism 10 can be transmitted to a host computer (not shown). Furthermore, in the multifunctional machine 1, images read by the image reading mechanism 10 can be printed on the paper S, and still image data or a moving image file stored in the memory card MC can be printed on the paper S. In such printing, the brightness and the color tone of images are enhanced. When printing a moving image file, it is possible to select “single frame printing” for printing one frame among a plurality of frames constituting the moving image file, or “multiple frame printing” for printing a plurality of frames that are a part of frames constituting the moving image file. Herein, the multiple frame printing is performed in order to provide the user with fun, for example. Thus, the multiple frame printing is also referred to as “fun print”.

Herein, in a case where the multiple frame printing (fun print) of a particular moving image file is performed, objects (scenes) of each of the frames that are to be printed vary depending on the way of selecting time range. Here, when each of the frames are constituted by objects similar to those in other frames, it is preferable to perform the image enhancement on each of the frames under a uniform condition. The reason for this is that the brightness and the color tone of the objects of each of the frames are made uniform. On the contrary, when each frame is constituted by objects different from those in other frames, it is preferable to perform the image enhancement on each frame under different conditions. The reason for this is that the quality of the printed images is improved when printing is performed with the brightness and the color tone optimized for each frame.

In view of these circumstances, the controller 60 (the CPU 62) performs the following processes in the multiple frame printing. More specifically, the controller 60 performs (1) a target frame determining process of determining a plurality of target frames that are to be printed, from among a plurality of frames constituting a moving image file, (2) a grouping process of dividing the plurality of target frames into a plurality of groups according to the type of objects in the frames (hereinafter, referred to as “object-based type”), and (3) an image enhancing process of performing image enhancement on the target frames belonging to a particular group uniformly under a condition that is associated with the corresponding type, and of performing the image enhancement on the target frames belonging to another group uniformly under another condition that is associated with the corresponding type. It should be noted that the controller 60 serves as a target frame determining section when performing the target frame determining process, serves as a grouping section when performing the grouping process, and serves as an image enhancing section when performing the image enhancing process.

With this configuration, target frames having high relevance to each other belong to the same group, and the image enhancement is performed on this group under a uniform condition. Thus, it is possible to suppress unevenness of the color and the like between the target frames. Since a condition for enhancement is set for each group, the image enhancement is performed under the condition that is suitable for that group. As a result, appropriate image enhancement can be achieved. Hereinafter, this is described in detail.

### Regarding the Detail of the Moving Image Printing Process

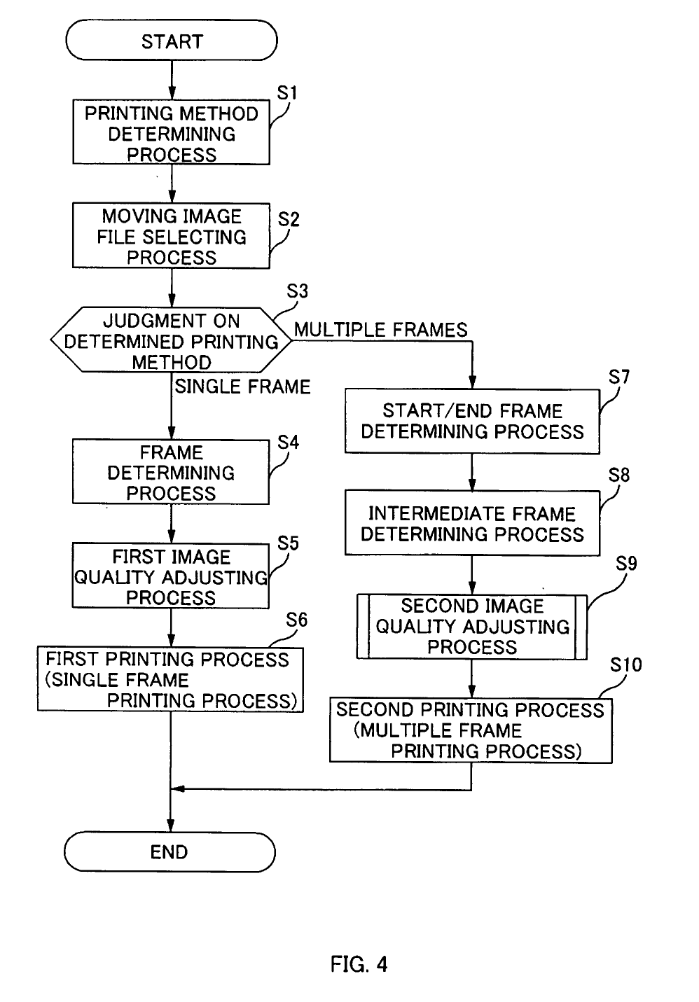

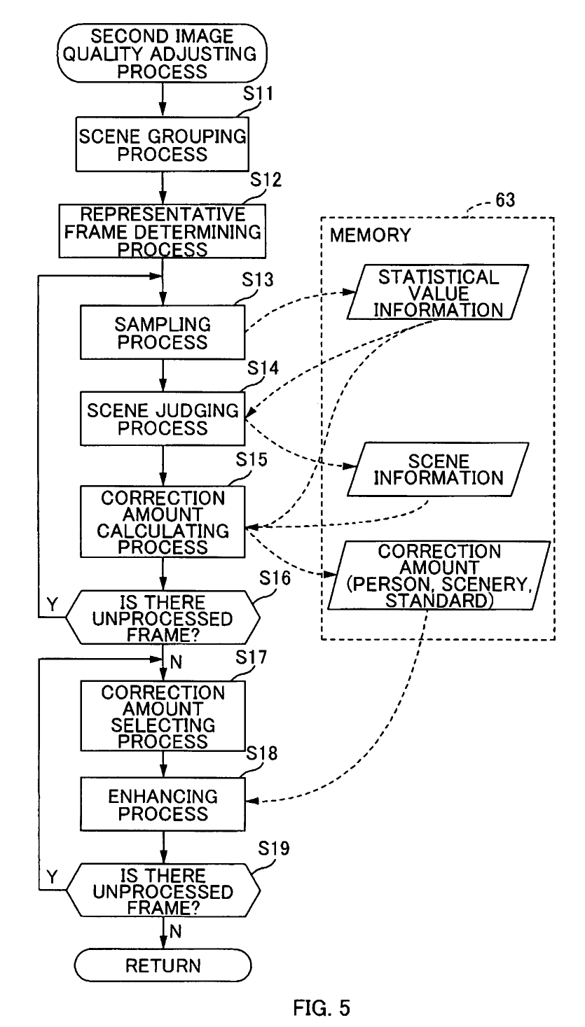

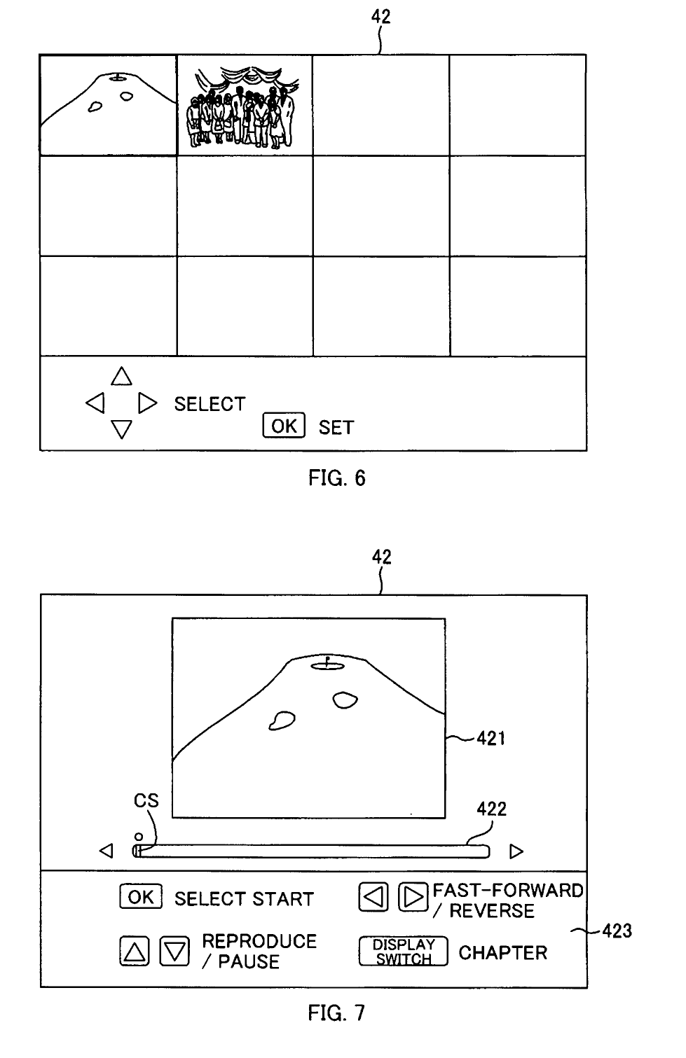

Hereinafter, the moving image printing process in the multifunctional machine 1 is described in detail. FIG. 4 is a flowchart illustrating each of the processes in a printing operation. FIG. 5 is a flowchart illustrating a second image quality adjusting process. FIG. 6 is a view illustrating one example of a user interface when selecting a moving image file. These processes are performed by the controller 60. More specifically, these processes are performed by the CPU 62 following computer programs stored in the memory 63. Accordingly, the computer programs have codes for causing the CPU 62 to execute each process.

In the moving image printing process, first, the controller 60 performs a printing method determining process (S1). The printing method determining process is a process of determining whether the single frame printing or the multiple frame printing is to be used as the printing method. In this process, the controller 60 displays, on the display section 42, a menu screen containing the item “single frame printing” and the item “multiple frame printing”, and waits for signals from the input section 43 (the mode switching button 436, the four-way button 431, the OK button 432, and the like). Then, the controller 60 recognizes the printing method specified by the user, based on the signals from the input section 43, and causes the memory 63 to store information indicating the printing method.

Next, the controller 60 performs a moving image file selecting process (S2). The moving image file selecting process is a process for making the user select a moving image file that is to be printed. In this process, the controller 60 recognizes moving image files targeted for printing, and displays a menu screen for prompting selection on the display section 42. For example, as shown in FIG. 6, first frames in the moving image files are shown as thumbnails. In FIG. 6, an example is shown in which first frames of two moving image files are displayed. Then, the controller 60 waits for signals from the input section 43, and recognizes a moving image file specified by the user, based on the signals from the input section 43. The controller makes the memory 63 store information indicating the file name or the address of the recognized moving image file (path information indicating the drive name or the folder name, for example).

Next, the controller 60 judges the determined printing method (S3). The judgment is made in order to determine the process that is to be performed next. More specifically, if the determined printing method is the single frame printing, then the controller 60 determines that a frame determining process (S4) is to be performed next, and the procedure proceeds to step S4. If the determined printing method is the multiple frame printing, then the controller 60 determines that a start/end frame determining process (S7) is to be performed next, and the procedure proceeds to step S7. First, the case in which the determined printing method is the single frame printing is described.

The frame determining process (S4) is a process of determining a frame that is to be printed (also referred to as a “target frame”) in the single frame printing. In this process, the controller 60 determines one frame that is to be printed, from among a plurality of frames constituting a moving image file. Thus, the controller 60 displays, on the display section 42, the time that has elapsed since the shooting was started and a frame corresponding to this elapsed time, and waits for the input from the input section 43. The user changes the elapsed time by operating the input section 43 (the four-way button 431, for example). Then, the user determines the frame that is to be printed, by operating the OK button 432 or the like when a desired frame is displayed. With this operation, the controller 60 determines the corresponding frame as the target frame, and causes the memory 63 to store information indicating the target frame.

After the target frame has been determined, then a first image quality adjusting process is performed (S5). The first image quality adjusting process is a process of adjusting the image quality of a target frame. More specifically, in this process, the controller 60 judges the type of the target frame, and performs the image enhancement suitable for this type. In the multifunctional machine 1, three object-based types are prepared. More specifically, three types which are “person”, “scenery”, and “standard” are prepared. If the target frame is judged as the “person” type, then hues are enhanced such that a face portion of a person in the target frame matches the standard skin color. Furthermore, brightness is also enhanced. If the target frame is judged as the “scenery” type, then the controller 60 performs the enhancement so as to increase the saturation in green portions, blue portions, and red portions in the target frame. If the target frame is judged as the “standard” type, then the controller 60 performs the enhancement so as to increase the brightness in the target frame and the saturation of each color.

After the image enhancement on the target frame has been performed, then the controller 60 performs a first printing process (S6). The first printing process is a printing process performed for one target frame. For example, a process is performed in which the target frame after the image enhancement is printed on the paper S with a predetermined size. At that time, the controller 60 makes the image of the target frame to be printed on the paper S, by controlling the printing mechanism 20.

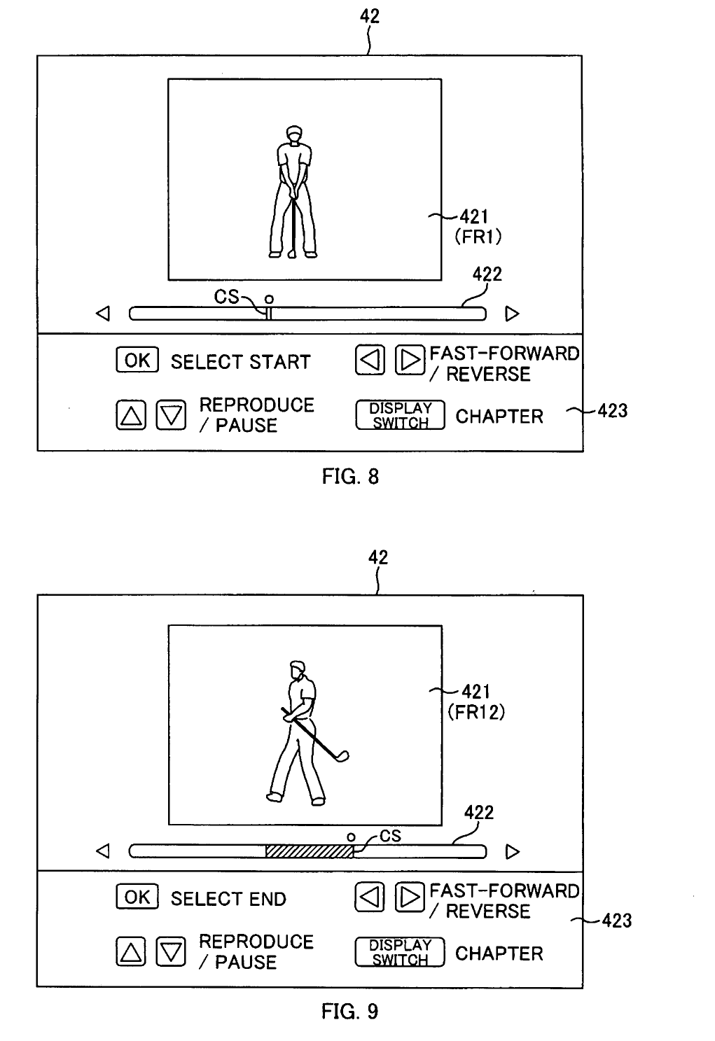

Next, the case is described in which the determined printing method is the multiple frame printing. In this case, the controller 60 performs the start/end frame determining process in step S7. FIG. 7 is a view illustrating one example of the user interface in the start/end frame determining process. FIG. 8 is a view illustrating one example of the user interface when determining a start frame. FIG. 9 is a view illustrating one example of the user interface when determining an end frame. The start/end frame determining process is a process of specifying a first target frame (hereinafter, also referred to as a “start frame”) and a last target frame (hereinafter, also referred to as an “end frame”) that are to be printed, in a moving image file that is to be printed. In this process, the controller 60 functions as the target frame determining section.

First, the controller 60 displays a selection image on the display section 42. The selection image herein contains a frame display area 421, a cursor display area 422, and a display area 423 for illustrating operation contents. The frame display area 421 is for displaying an image of an arbitrary frame. In the multifunctional machine 1, the frame display area 421 first displays a first frame in the moving image file. When the left side portion or the right side portion of the four-way button 431 is operated, a frame targeted for display changes. For example, when the right side portion is pressed, a frame after the currently-displayed frame is displayed. When the left side portion is pressed, a frame before the currently-displayed frame is displayed.

The cursor display area 422 displays a cursor CS that can move in a lateral direction. The cursor CS indicates the elapsed time at the displayed frame in the moving image file. For example, in the example shown in FIG. 7, the first frame in the moving image file is displayed. Thus, the cursor CS is displayed at the left end in the cursor display area 422. In the example shown in FIG. 8, a frame in the state which approximately 40% of the total time has elapsed is displayed. Thus, the cursor CS has moved in the display area by approximately 40% of the display range from the left end to the right side. Similarly, in the example shown in FIG. 9, a frame in the state which approximately 60% of the total time has elapsed is displayed. Thus, the cursor CS has moved in the display area by approximately 60% of the display range from the left end to the right side.

If the user presses the OK button 432 in a state where a desired frame is displayed, then the frame at that point (corresponding to a “particular frame”) is determined to be the start frame. After the start frame has been determined, if the user presses the OK button 432 in a state where a desired frame after the start frame is being displayed, then the frame at that point (corresponding to “another frame”) is determined to be the end frame. For example, if the user presses the OK button 432 in the state shown in FIG. 8 and then presses the OK button 432 in the state shown in FIG. 9, then a frame in which a golfer (person) is at the address position is determined to be the start frame, and a frame in which the golfer is walking after hitting a shot is determined to be the end frame. The start frame corresponds to the first target frame, and the end frame corresponds to the last target frame.

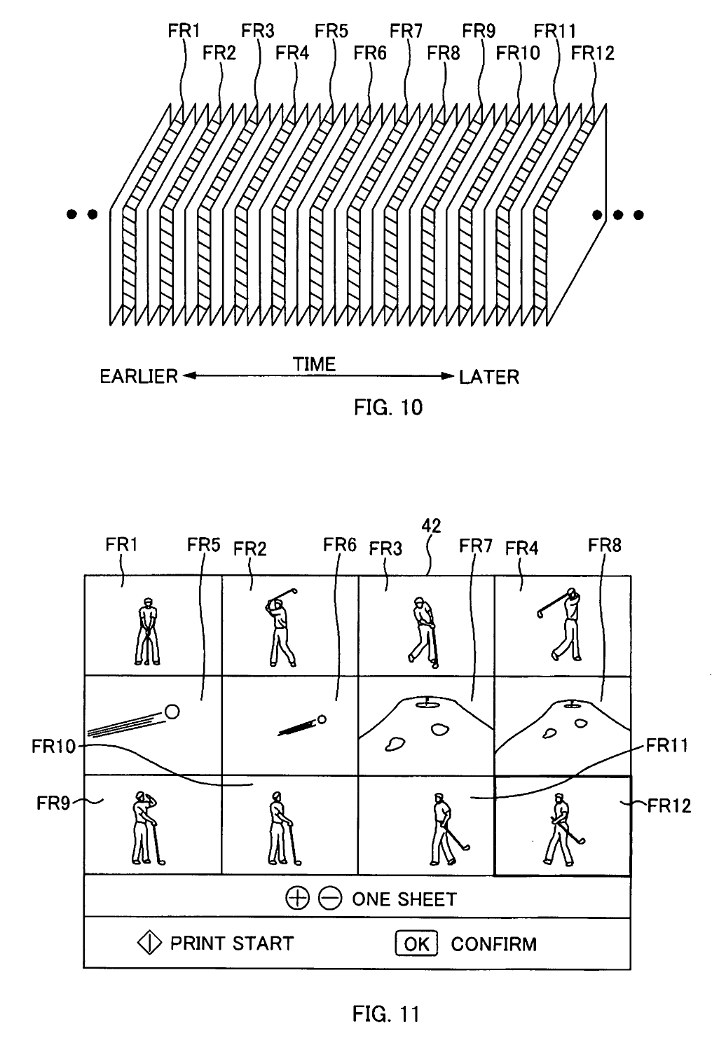

After the start frame and the end frame have been determined, then the controller 60 performs an intermediate frame determining process (S8). FIG. 10 is a diagram for illustrating target frames. An intermediate frame is a frame that is determined between the start frame and the end frame, and is a frame that is to be printed. Accordingly, the intermediate frame can be also referred to as an intermediate target frame. Then, the controller 60 can be said to function as the target frame determining section also during this process. The start/end frame determining process (S7) and the intermediate frame determining process (S8) correspond to a target frame determining process.

In the intermediate frame determining process, the controller 60 determines a plurality of intermediate frames between the start frame and the end frame such that the successive target frames are arranged at a constant time interval. In the multifunctional machine 1, when the multiple frame printing is selected, twelve target frames are printed on one sheet of paper S. Thus, in a case where a frame indicated by the symbol FR1 in FIG. 10 is determined to be the start frame, and a frame indicated by the symbol FR12 is determined to be the end frame, frames indicated by the symbols FR2 to FR11 are determined to be the intermediate frames. In the example shown in FIG. 10, the intermediate frames FR2 to FR11 are determined such that the intermediate frames and other target frames constituting the successive frames are arranged at a constant time interval. In this example, each of the intermediate frames FR2 to FR11 has two frames between the intermediate frame and another target frame. In other words, each of the target frames FR1 to FR12 are determined with two frame intervals. It should be noted that the number of frames interposed is two for the sake of convenience, however the actual number is not limited to this number. More specifically, the number of frames interposed is determined based on factors such as the time from the start frame to the end frame, the number of target frames, and the frame rate when images were photographed.

After the intermediate frames have been determined, then a second image quality adjusting process is performed (S9). The second image quality adjusting process is a process of adjusting the image quality of a plurality of target frames. The second image quality adjusting process is described later in detail.

After the second image quality adjusting process has been performed, then the controller 60 performs a second printing process (S10). The second printing process is a printing process for a plurality of target frames. The controller 60 controls the printing mechanism 20 that functions as the image printing section, thereby causing the plurality of target frames (the start frame, the intermediate frames, and the end frame) after the image enhancement to be printed on one sheet of paper S. FIG. 11 shows one example of the display screen on the display section 42 in the second printing process. In the second printing process, as shown in FIG. 11, first, the plurality of target frames are displayed on the display section 42. It should be noted that the target frame displayed at the left end in the upper row in FIG. 11 is the start frame (the first target frame FR1) and the target frame displayed at the right end in the lower row is the end frame (the twelfth target frame FR12). Furthermore, the other target frames FR2 to FR11 are the intermediate frames. Each of the target frames FR1 to FR12 are displayed in chronological order from the left end in the upper row to the right end in the lower row. More specifically, among the twelve displayed target frames, four target frames that are arranged in the upper row are the first target frame FR1 to the fourth target frame FR4. A target frame photographed earlier is displayed closer to the left side. Similarly, four target frames that are arranged in the middle row are the fifth target frame FR5 to the eighth target frame FR8, and four target frames that are arranged in the lower row are the ninth target frame FR9 to the twelfth target frame FR12.

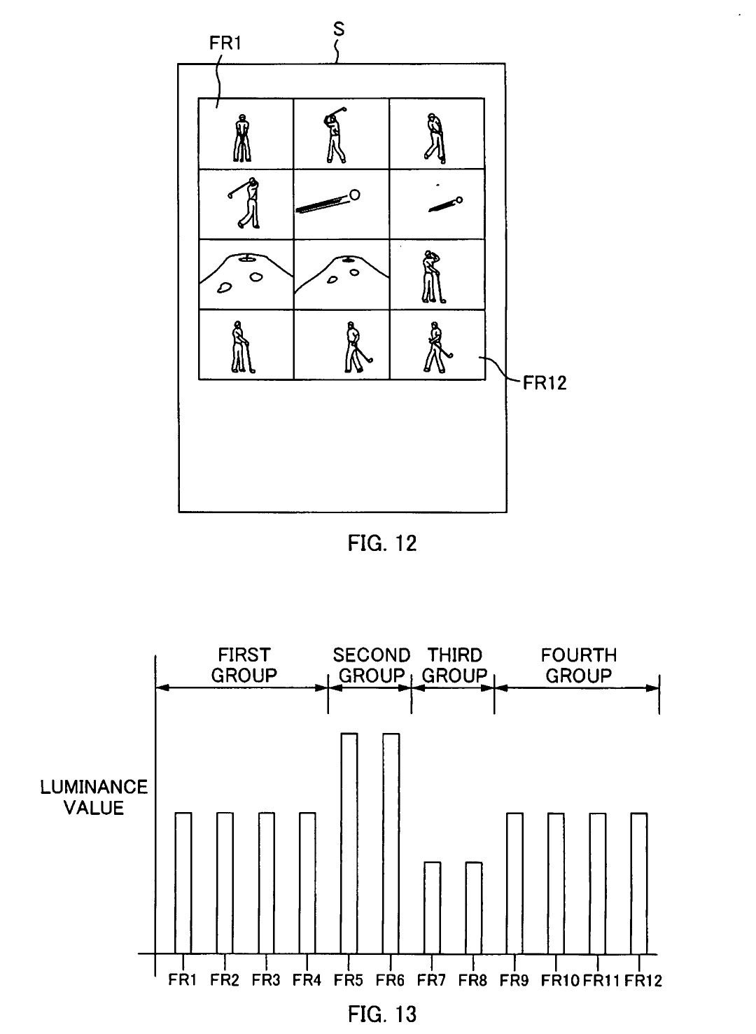

When the user sequentially presses the OK button 432 and the start button 438, printing on the paper S is started. More specifically, the controller 60 causes the plurality of target frames FR1 to FR12 after the image enhancement to be printed on one sheet of paper S. FIG. 12 is a view showing one example of printed images. As shown in FIG. 12, three frames are arranged in the width direction of the paper S (corresponding to the carriage movement direction), and four frames are arranged in the length direction of the paper S (corresponding to the transport direction). Thus, twelve frames in total are printed on one sheet of paper S. It should be noted that the arrangement order of the target frames FR1 to FR12 (images) printed on the paper S is the same as that of the target frames FR1 to FR12 displayed on the display section 42. Thus, a description thereof has been omitted.

### Regarding the Second Image Quality Adjusting Process

Next, the second image quality adjusting process is described. In the second image quality adjusting process, the controller 60 functions as the grouping section and the image enhancing section. More specifically, the controller 60 performs a grouping process [a scene grouping process (S11), a representative frame determining process (S12), and a scene judging process (S14), for example], thereby dividing the plurality of target frames FR1 to FR12 into a plurality of groups according to object-based types. For example, the target frames are divided into a group associated with the “person” type, a group associated with the “scenery” type, and a group associated with the “standard” type. Then, the controller 60 performs an image enhancing process (S18), thereby performing the image enhancement on the target frames belonging to a particular group under a condition that is associated with the corresponding type, and performing the image enhancement on the target frames belonging to another group uniformly under another condition that is associated with the corresponding type. For example, if a particular group is the “person” type, then the image enhancement on the target frames belonging to this group is performed under a condition that is suitable for the person type. More specifically, the image enhancement is performed such that a face portion of a person matches the standard skin color. If a particular group is the “scenery” type, then the enhancement is performed on the target frames belonging to this group so as to increase saturation in green portions, blue portions, and red portions. Hereinafter, this is described in detail.

As shown in FIG. 5, in the second image quality adjusting process, the controller 60 performs a scene grouping process (S11), thereby dividing the plurality of target frames FR1 to FR12 into a plurality of groups. It should be noted that the groups into which the target frames are divided in the scene grouping process are groups whose object-based types have not been specified yet. In this process, the controller 60 divides the target frames FR1 to FR12 into groups based on their luminance values.

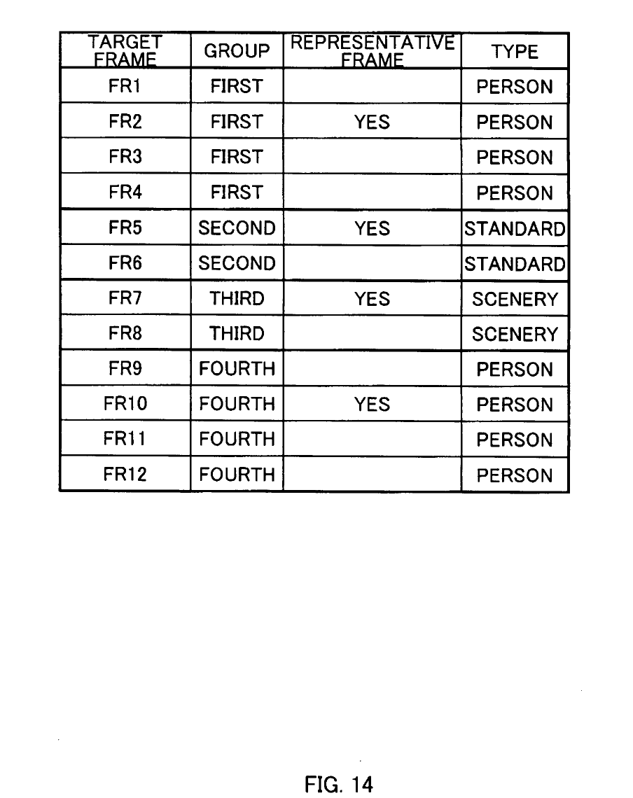

FIG. 13 is a diagram schematically illustrating the grouping process, and shows the luminance value of each of the target frames FR1 to FR12 shown in FIG. 11. FIG. 14 is a diagram illustrating the classification items of the target frames FR1 to FR12. The first target frame FR1 to the fourth target frame FR4 in FIG. 11 display a golfer (person) that is performing a golf swing. The fifth target frame FR5 and the sixth target frame FR6 display a golf ball that is flying. The seventh target frame FR7 and the eighth target frame FR8 display a fairway. The ninth target frame FR9 to the twelfth target frame FR12 display the golfer after the swing. Thus, as shown in FIG. 13, regarding the luminance values of the target frames FR1 to FR12, the first target frame FR1 to the fourth target frame FR4, and the ninth target frame FR9 to the twelfth target frame FR12 indicate similar values. Furthermore, the fifth target frame FR5 and the sixth target frame FR6 indicate similar values, and the seventh target frame FR7 and the eighth target frame FR8 indicate similar values.

The controller 60 divides the plurality of target frames FR1 to FR12 into groups, by comparing the luminance values of each of the successive target frames. First, the controller 60 acquires each of the luminance value of the first target frame FR1 and the luminance value of the second target frame FR2, obtains the difference between the acquired luminance values, and compares the difference with a threshold value. The threshold value has been stored as threshold value information, for example, in the memory 63. If the difference between the luminance values is less than the threshold value, then it is judged that the target frames belong to the same group. On the other hand, if the difference is greater than or equal to the threshold value, then it is judged that the target frames belong to different groups. In the example shown in FIG. 13, each of the luminance values are substantially the same. Thus, the controller 60 judges that the first target frame FR1 and the second target frame FR2 belong to the same group. Next, the controller 60 performs a similar judgment on the second target frame FR2 and the third target frame FR3. In the example shown in FIG. 13, the luminance value of the second target frame FR2 and the luminance value of the third target frame FR3 are substantially the same. Thus, the controller 60 judges that the second target frame FR2 and the third target frame FR3 also belong to the same group. By performing such process sequentially up to the twelfth target frame FR12, the plurality of target frames FR1 to FR12 are divided into a plurality of groups. In the example shown in FIG. 13, the first target frame FR1 to the fourth target frame FR4 are classified into the same group (for the sake of convenience, referred to as a “first group”: the other groups are also referred in this manner). Furthermore, the fifth target frame FR5 and the sixth target frame FR6 are classified into a second group, the seventh target frame FR7 and the eighth target frame FR8 are classified into a third group, and the ninth target frame FR9 to the twelfth target frame FR12 are classified into a fourth group respectively.

After the plurality of target frames FR1 to FR12 have been divided into groups, the controller 60 performs a representative frame determining process (S12). Here, a representative frame refers to a target frame based on which the type of the group is determined. In this embodiment, the controller 60 sets, as the representative frame, the middle target frame of target frames constituting each group. Moreover, when there are two middle target frames, then the former target frame is set as the representative frame. For example, the first group is constituted by four target frames. Thus, the second target frame FR2 and the third target frame FR3 can be considered as the middle target frame. Here, the controller 60 sets the second target frame, which is the former target frame, as the representative frame. The representative frames are set in a similar manner also for the other groups. As shown in FIG. 14, the fifth target frame FR5 is set as the representative frame in the second group. Furthermore, the seventh target frame FR7 is set as the representative frame in the third group, the tenth target frame FR10 in the fourth group respectively.

After the representative frames have been set for the groups, the controller 60 performs a sampling process (S13). The sampling process is a process of acquiring information regarding luminance, hues, and the like of a particular representative frame. In this process, the controller 60 acquires information regarding the luminance value, the number and the coordinates of R (red) pixels, the number and the coordinates of G (green) pixels, the number and the coordinates of B (blue) pixels, the edge amount, and the like, of a target representative frame. First, the controller 60 acquires information of the second target frame FR2 that serves as the representative frame in the first group. Then, the acquired information is stored as statistical value information in the memory 63.

After the statistical value information has been stored, then the controller 60 performs a scene judging process (S14). The scene judging process is a process of judging a scene of a representative frame. The scene herein corresponds to an object-based type. Accordingly, the scene judging process on the representative frame corresponds to a type judging process on the representative frame. As described above, the types herein include three types which are “person”, “scenery”, and “standard”. The controller 60 judges the type of the representative frame, among the “person”, “scenery”, and “standard” types. At that time, the controller 60 first reads out the statistical value information stored in the memory 63, and judges whether or not the representative frame can be classified as the “person” type. This judgment is made based on whether or not a face portion is present. The outline is briefly described as below. First, the controller 60 judges whether or not a skin-colored portion is present in the representative frame. If a skin-colored portion is present, then the controller 60 judges whether or not portions corresponding to the eyes and the mouth are present in that portion. If the portions corresponding to the eyes and the mouth are present, then the skin-colored recognized portion is recognized as a face portion. Furthermore, if the area of the face portion is 0.5% or more of the area of the representative frame, then the type of the representative frame is judged as the “person” type. And when the type is not judged as the “person” type, the controller 60 judges whether or not the representative frame can be classified as the “scenery” type. This judgment is made using, for example, a histogram. In this case, the controller 60 obtains a histogram, by obtaining the degrees of each item such as the luminance value, the number of R pixels, the number of G pixels, the number of B pixels, the edge amount, and the like. Based on the shape of the obtained histogram, the type of the representative frame is judged. For example, if the ratios of green, blue, and red, which often appear in scenery, are high, then the matching with the histogram of scenery becomes high. Thus, the controller 60 judges the representative frame as the “scenery” type. Furthermore, the controller 60 judges a representative frame as the “standard” type in a case where the representative frame has been judged as neither the “person” type nor the “scenery” type. The judgment results are stored as scene information in the memory 63.

After the type judgment (scene judgment) of the representative frame has been performed, then the controller 60 performs a correction amount calculating process (S15). At that time, the controller 60 functions as a correction amount calculating section. The correction amount calculated in this process can be referred to as the difference between the color of the representative frame obtained in the sampling process (S13) and a desired color (standard color). Accordingly, the correction amount calculating process can be said to be a process of calculating the difference between the color of the representative frame and the standard color, for each of a plurality of correction items. Examples of the correction items used in the multifunctional machine 1 are “brightness”, “contrast”, “saturation”, “color balance”, and “sharpness”. It should be noted that these correction items are only examples, and other items are also set. Herein, if the representative frame is judged as the “person” type, then the correction amount is calculated such that a face portion of a person in the representative frame becomes the standard skin color. If the representative frame is judged as the “scenery” type, then correction values are calculated so as to increase saturation in green portions, blue portions, and red portions in the representative frame. If the representative frame is judged as the “standard” type, then the correction amount is calculated such that the representative frame is slightly brighter, and saturation of each color is slightly increased. The controller 60 causes the memory 63 to store the calculated correction amount.

After the correction amounts based on the representative frame have been calculated, then the controller 60 judges whether or not there is an unprocessed representative frame in another group (S16). And if there is an unprocessed representative frame, the sampling process (S13) and the following processes are performed on the representative frame again. For example, after the correction amount has been calculated for the representative frame (the second target frame FR2) in the first group, the controller 60 performs the sampling process (S13) and the following processes on the representative frame (the fifth target frame FR5) in the second group. And after the correction amount has been calculated for the representative frame (the tenth target frame FR10) in the fourth group, there is no more unprocessed representative frame. In this case, the controller 60 performs a correction amount selecting process (S17). With the series of processes from the sampling process (S13) to the correction amount calculating process (S15), the scene information (information of the object-based type) and the corresponding correction amount are determined for each group and stored in the memory 63. In the example shown in FIG. 14, the first group and the fourth group display a golfer that is performing a swing, and are thus judged as the person type. The second group displays a ball that is flying, and is thus judged as the standard type. The third group displays a fairway, and is thus judged as the scenery type.

The correction amount selecting process (S17) is a process of selecting the correction amount suitable for a target frame that is to be corrected. Herein, the correction amount corresponds to a condition for performing the image enhancing process. For example, when the correction amount determined based on the representative frame (the second target frame FR2) belonging to the person type is taken as a “particular condition”, the correction amount determined based on the representative frame (the seventh target frame FR7) belonging to the scenery type and the correction amount determined based on the representative frame (the fifth target frame FR5) belonging to the standard type correspond to “other conditions”. Thus, the correction amount selecting process corresponds to a correction condition selecting process. The controller 60 can be said to function as a correction condition selecting section, when performing the correction amount selecting process. In the correction amount selecting process, the controller 60 acquires the type of a target frame on which image enhancement is to be performed, and acquires the corresponding correction amount. For example, if a target frame on which image enhancement is to be performed is the first target frame FR1, then the controller 60 selects the correction amount associated with the person type, based on information of the group (the first group) to which this target frame belongs. If a target frame on which image enhancement is to be performed is the fifth target frame FR5, then the controller 60 selects the correction amount associated with the standard type, based on information of the group (the second group) to which this target frame belongs.

The image enhancing process (S18) is a process of performing the image enhancement on a particular target frame. In this process, the controller 60 functions as the image enhancing section, and performs the image enhancement using the selected correction amount on the corresponding target frame. In this embodiment, first, the image enhancement is performed on the first target frame FR1 (the start frame). In this case, the controller 60 performs the image enhancement using the correction amount associated with the person type. After the image enhancement on the target frame has ended, then the controller 60 judges whether or not there is an unprocessed target frame on which the image enhancement has not been performed (S19). For example, when the image enhancement has ended on the first target frame FR1, it is judged that there are unprocessed target frames. The correction amount selecting process (S17) and the image enhancing process (S18) are performed on the second target frame FR2 with the lowest number, among the second target frame FR2 to the twelfth target frame FR12 that are unprocessed target frames. Hereafter, similar processes are repeated, and the controller 60 ends the second image quality adjusting process (S9) when the image enhancing process on the twelfth target frame FR12 (the end frame) has ended.

After the second image quality adjusting process has ended, then the controller 60 performs the second printing process (S10) as described above. Thus, for example, images shown in FIG. 12 are printed on the paper S. Herein, in the multifunctional machine 1, the image enhancement is performed under a uniform condition on the target frames belonging to the same group. For example, the first target frame FR1 to the fourth target frame FR4 belong to the first group associated with the person type. Thus, the enhancement is performed uniformly by the correction amount associated with the person type, which has been obtained for the representative frame (the second target frame) in the first group. The fifth target frame FR5 and the sixth target frame FR6 belong to the second group associated with the standard type. Thus, the enhancement is performed uniformly by the correction amount associated with the standard type, which has been obtained for the representative frame (the fifth target frame) in the second group. Similarly, the enhancement is performed on the seventh target frame FR7 and the eighth target frame FR8 uniformly by the correction amount associated with the scenery type, and the enhancement is performed on the ninth target frame FR9 to the twelfth target frame FR12 uniformly by the correction amount associated with the person type. Accordingly, the color tone can be made uniform more easily between target frames that have high relevance to each other and are classified into one group. More specifically, appropriate enhancement can be achieved. For example, the image enhancement is performed on target frames belonging to a group associated with the person type, uniformly by the correction amount (condition) that has been determined based on an image of a face portion of a person. The image enhancement is performed on target frames belonging to a group associated with the scenery type, uniformly by the correction amount (condition) that has been determined using the colors constituting scenery (green, blue, and red, for example) as a reference. Thus, the enhancement is performed on the target frames of the person type such that the face color matches the standard color, and the enhancement is performed on the target frames of the scenery type so as to increase saturation in green portions, blue portions, and red portions. Thus, the enhancement that is suitable for that group is selected, and the enhancement is performed uniformly on target frames belonging to the same group. More specifically, unevenness of the color is suppressed. As a result, the quality of printing can be improved when each of the frame images are arranged on one sheet of paper S as in FIG. 12.

### SUMMARY

As described above, in a case where the “multiple frame printing” is selected, the controller 60 divides the plurality of target frames FR1 to FR12 into groups according to the object-based types. Then, the controller 60 obtains the correction amount for each group, thereby performing the image enhancement on the target frames belonging to a particular group uniformly under a condition that is associated with the corresponding type, and performing the image enhancement on the target frames belonging to another group uniformly under another condition that is associated with the corresponding type. For example, the image enhancement is performed uniformly on each of the target frames FR1 to FR4 in the first group that has been judged as the person type, using the correction amount that has been determined based on the second target frame. Furthermore, the image enhancement is performed uniformly on the third group that has been judged as the scenery type, using the correction amount that has been determined based on the seventh target frame FR7. Thus, appropriate image enhancement can be achieved.

Furthermore, when the plurality of target frames FR1 to FR12 are divided into a plurality of groups according to the object-based types, the controller 60 first divides the target frames into groups without specifying the types, and then judges the type of each group. More specifically, the types of certain target frames (the second target frame FR2, the fifth target frame FR5, the seventh target frame FR7, and the tenth target frame FR10, as the representative frames) are judged. Thus, the time that is necessary to judge the type can be shortened, and the process can be performed at high speed. Furthermore, when the target frames are divided into a plurality of groups, the luminance value of each target frame is used. More specifically, it is judged whether or not target frames belong to the same group, by comparing the luminance values of the successive target frames. Thus, the process can be made simple and can be suitably performed at high speed.

### Other Embodiments

The foregoing embodiment described the image enhancing apparatus that was realized as the multifunctional machine 1, but it also includes a description of an image enhancing method, and a computer program and a code for controlling the image enhancing apparatus. Moreover, this embodiment is for the purpose of elucidating the invention, and is not to be interpreted as limiting the invention. It goes without saying that the invention can be altered and improved without departing from the gist thereof and includes functional equivalents. In particular, embodiments described below are also included in the invention.

### Regarding the Image Enhancing Apparatus

The foregoing embodiment describes a configuration in which the multifunctional machine 1 was used as the image enhancing apparatus. However, the image enhancing apparatus is not limited to the multifunctional machine 1. For example, it is also possible to use, as the image enhancing apparatus, a printer that performs only printing. In this case, the printer is used as the image enhancing apparatus, by causing the printer to execute a program for image enhancement. Furthermore, a computer that executes a program for image enhancement may constitute the image enhancing apparatus. Furthermore, a digital camera may be used as the image enhancing apparatus.

### Regarding the Representative Frame

The representative frame that represents each frame is not limited to the middle target frame in that group. For example, it is also possible to use the first target frame or the last target frame in that group.

### Regarding the Type of the Target Frame

The foregoing embodiment describes the types of the target frames using the three types “person”, “scenery”, and “standard” as an example. However, the types of the target frames are not limited to these, and it is also possible to use other types.

### Regarding the Printing Mode

The foregoing embodiment described the mode in which a plurality of target frames were printed on the same paper S, but the printing mode is not limited to this. For example, it is also possible to apply a mode in which a plurality of target frames are printed on different sheets of paper S.

### Regarding the Memory Card MC

The foregoing embodiment describes a configuration in which the memory card MC was attached to the card slot 50, but the configuration is not limited to this. For example, in a state where a digital camera is connected via a cable to the multifunctional machine 1, the memory card MC attached to the digital camera may be accessed via the cable.

What is claimed is:

1. An image enhancing method, comprising:
(A) classifying a plurality of target frames that are to be output into at least one group based on a predetermined criterion, the target frames being determined from among a plurality of frames constituting a file; and
(B) performing image enhancement on the target frames belonging to a particular group, uniformly under a condition that is associated with the particular group.

2. An image enhancing method according to claim 1,
wherein the plurality of target frames are classified into a plurality of groups according to a type of an object in a frame.

3. An image enhancing method according to claim 2,
wherein image enhancement on the target frames belonging to the particular group is performed uniformly under a condition that is associated with the particular group, and image enhancement on the target frames belonging to another group is performed uniformly under a condition that is associated with the other group.

4. An image enhancing method according to claim 2,
wherein the plurality of target frames are classified into a plurality of groups without specifying the type, and
the type is specified for each group after the target frames are classified into the plurality of groups.

5. An image enhancing method according to claim 2,
wherein the plurality of target frames are classified into the plurality of groups, by comparing luminance values among the successive target frames.

6. An image enhancing method according to claim 2,
wherein a representative frame is determined from among the target frames belonging to a particular group, and a type of the representative frame is taken as the type of the particular group.

7. An image enhancing method according to claim 2,
wherein the type of an object in a frame includes at least a person type.

8. An image enhancing method according to claim 7,
wherein image enhancement on the target frames belonging to a group that is associated with the person type is performed uniformly under a condition that is determined based on an image of a face portion of a person.

9. An image enhancing method according to claim 2,
wherein the type of an object in a frame includes at least a scenery type.

10. An image enhancing method according to claim 9,
wherein image enhancement on the target frames belonging to a group that is associated with the scenery type is performed uniformly under a condition that is determined based on colors constituting scenery.

11. An image enhancing method according to claim 1,
wherein the plurality of target frames are determined based on information for specifying a particular frame and information for specifying another frame that is recorded after the particular target frame.

12. An image enhancing apparatus, comprising:
(A) a group classifying section for classifying a plurality of target frames that are to be output into at least one group based on a predetermined criterion, the target frames being determined from among a plurality of frames constituting a file; and
(B) an image enhancing section for performing image enhancement on the target frames belonging to a particular group, uniformly under a condition that is associated with the particular group.
